(19) United States
(12) Patent Application Publication
(10) Pub. No.: US 2023/0064155 A1
(43) Pub. Date: Mar. 2, 2023

(54) GAS REGULATOR WITH OVERLOAD PROTECTION FUNCTION

(71) Applicant: Te Feng LIN, TAIPEI (TW)

(72) Inventor: Te Feng LIN, TAIPEI (TW)

(21) Appl. No.: 17/409,897

(22) Filed: Aug. 24, 2021

(51) Int. Cl. F16K 17/30; F16K 27/02; F16K 17/06; F16K 17/164

(52) U.S. Cl. CPC F16K 17/30; F16K 17/06; F16K 17/164; F16K 27/02

(57) ABSTRACT

A gas regulator has a base and a blocking mechanism. The base has a transporting passage. The blocking mechanism has a plug, a first elastic unit, an elastic sealing sheet, and a switching unit. The plug is moveably mounted in the transporting passage and forms a gap for gas to pass through the transporting passage. The first elastic unit moves the plug to block an end opening of the transporting passage. The blocking chamber is formed between the elastic sealing sheet and the base. The switching unit is connected to the elastic sealing sheet and moves along with the deformation of the elastic sealing sheet relative to the plug. The switching unit abuts the plug to space the plug apart from the end opening. When the gas pressure is too high, the switching unit moves to allow the plug to move to block the end opening.

### BACKGROUND OF THE INVENTION

### 1. Field of the Invention

The present invention relates to a gas regulator for a gas cylinder, especially to a gas regulator having an overload protection function.

### 2. Description of the Prior Arts

With reference to FIG. 10, FIG. 10 is a side view in cross-section of a conventional gas regulator. Gas enters the adjusting chamber 92 from the inlet 91. In the adjusting chamber 92, the pressure of the gas pushes the elastic sealing sheet 93 and deforms the elastic sealing sheet 93 to push the spring 94 until the pressure of the gas and the force of the spring 94 achieve a balance. A moving unit 95 is mounted on the elastic sealing sheet 93. The moving unit 95 moves along with the deformation of the elastic sealing sheet 93. Under different gas pressures, since the elastic sealing sheet 93 has different deformations, the positions of the moving unit 95 are different. A lever 96 is pivotally mounted in the adjusting chamber 92. An end of the lever 96 is connected to the moving unit 95 and another end of the lever 96 is connected to a plug 97. When the moving unit 95 moves because of the changing gas pressure, the moving unit 95 pulls the lever 96 and the lever 96 moves the plug 97 to open a size-variable gap for allowing the gas to pass through to the outlet 98. By the abovementioned structure, the gas regulator can open a gap in an appropriate size for the gas which has different pressures before adjusted, thereby making the gas cylinder supply the gas stably and smoothly.

However, after a long term of use, the conventional gas regulator might lose the function for stabilizing the supplying pressure of the gas cylinder because the spring 94 suffers elastic fatigue or the elastic sealing sheet 93 is damaged, and then the gas cylinder will directly eject the gas under a high pressure. As a result, the force of the gas ejection will be too large and the ejection speed will be too fast, and eventually the flame will be large and far from the nozzle, which is not only difficult to use but also quite dangerous.

To overcome the shortcomings, the present invention provides a gas regulator with an overload protection function to mitigate or obviate the aforementioned problems.

### SUMMARY OF THE INVENTION

The main objective of the present invention is to provide a gas regulator with an overload protection function that directly blocks the gas after the function for stabilizing the supplying pressure is disabled, thereby avoiding danger.

The gas regulator has a base, a blocking mechanism, and an adjusting mechanism. The base has a gas inlet, a gas outlet, a transporting passage, and a first chamber. The transporting passage is formed inside the base. The first chamber is formed inside the base. The gas inlet communicates with the first chamber and the gas outlet via the transporting passage. Gas is capable of entering the base via the gas inlet. The blocking mechanism has a plug, a first elastic unit, an elastic sealing sheet, a second elastic unit, and a switching unit. The plug is moveably mounted in the transporting passage of the base. A gap is formed between the plug and an inner surface of the transporting passage. The gas is allowed to flow through the gap. The first elastic unit is connected to the plug and is configured to move the plug to block an end opening of the transporting passage so that the gas inlet and the gas outlet are blocked. The elastic sealing sheet is elastic and deformable. The blocking chamber is formed between the elastic sealing sheet and the base. The blocking chamber communicates with the first chamber. The gas is allowed to push the elastic sealing sheet to increase a volume of the blocking chamber. The second elastic unit is connected to the elastic sealing sheet and is configured to reduce the volume of the blocking chamber. The switching unit is connected to the elastic sealing sheet and moves along with the deformation of the elastic sealing sheet relative to the plug. The switching unit is capable of abutting the plug to make the plug spaced apart from the end opening of the transporting passage. Wherein when the gas pushes the elastic sealing sheet, the switching unit is moved so that the plug is allowed to be moved to block the end opening of the transporting passage by the first elastic unit. The adjusting mechanism is mounted in the first chamber and is capable of adjusting a pressure of the gas in the first chamber.

When in use, under normal circumstances, the plug is abutted by the switching unit to be spaced apart from the end opening of the transporting passage, and the gas can flow through the gap between the plug and the transporting passage and then flow to the first chamber and the gas outlet via the end opening. If the gas pressure is too high or the adjusting mechanism in the first chamber fails, since the blocking chamber communicates with the first chamber, the gas will push the elastic sealing sheet from the blocking chamber to deform the elastic sealing sheet. Then, the deformed elastic sealing sheet moves the switching unit relative to the plug, and allows the plug to be moved by the first elastic unit to block the end opening of the transporting passage. As a result, the over-pressured gas can be blocked to avoid danger.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a gas regulator in accordance with the present invention;

FIG. 2 is a perspective view of the gas regulator in FIG. 1, showing the adjusting mechanism and the blocking mechanism;

FIG. 3 is an exploded view of the gas regulator in FIG. 1, showing the adjusting mechanism and the blocking mechanism;

FIG. 4 is a side view in cross-section along the 1-1 cutting line in FIG. 1;

FIG. 5 is a side view in cross-section along the 2-2 cutting line in FIG. 1;

FIG. 5A is a side view in cross-section along the 3-3 cutting line in FIG. 1;

FIGS. 6 and 7 are operational views of the gas regulator in FIG. 1, showing the elastic sealing sheet and the switching unit;

FIGS. 8 and 9 are operational views of the gas regulator in FIG. 1, showing the plug; and

FIG. 10 is a side view in cross-section of a conventional gas regulator.

### DETAILED DESCRIPTION OF THE PREFERRED EMBODIMENTS

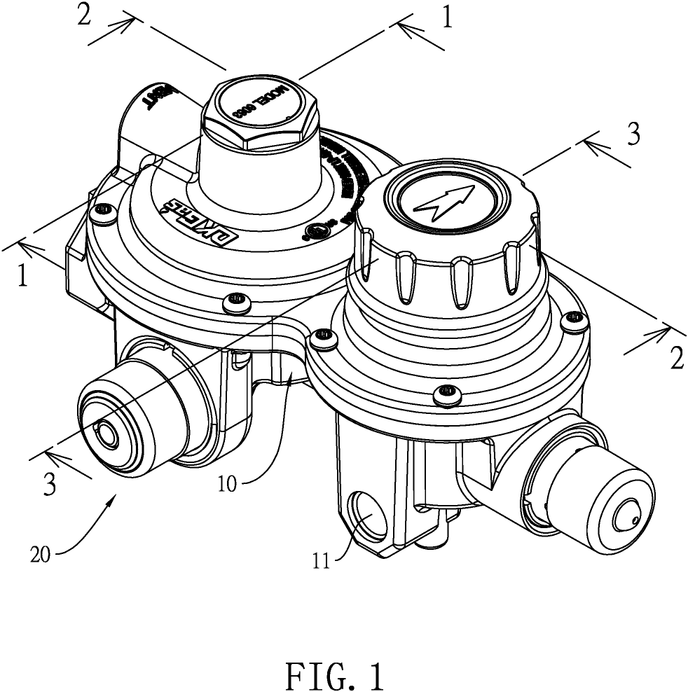

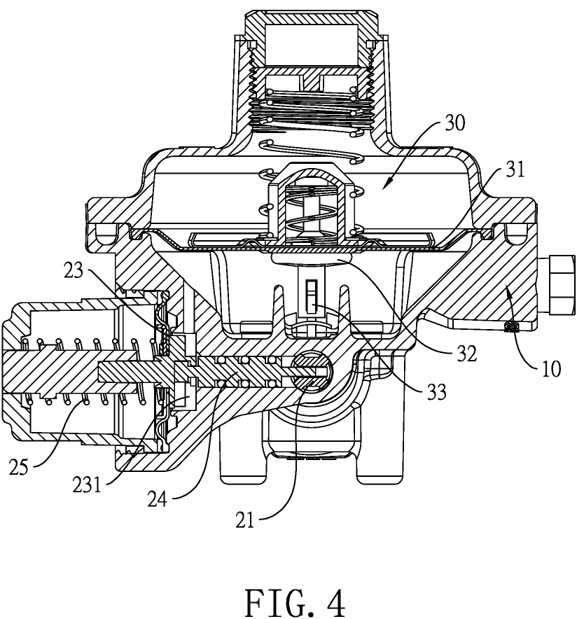

With reference to FIGS. 1, 2, 4, and 5, a gas regulator in accordance with the present invention comprises a base 10, a blocking mechanism 20, and an adjusting mechanism 30.

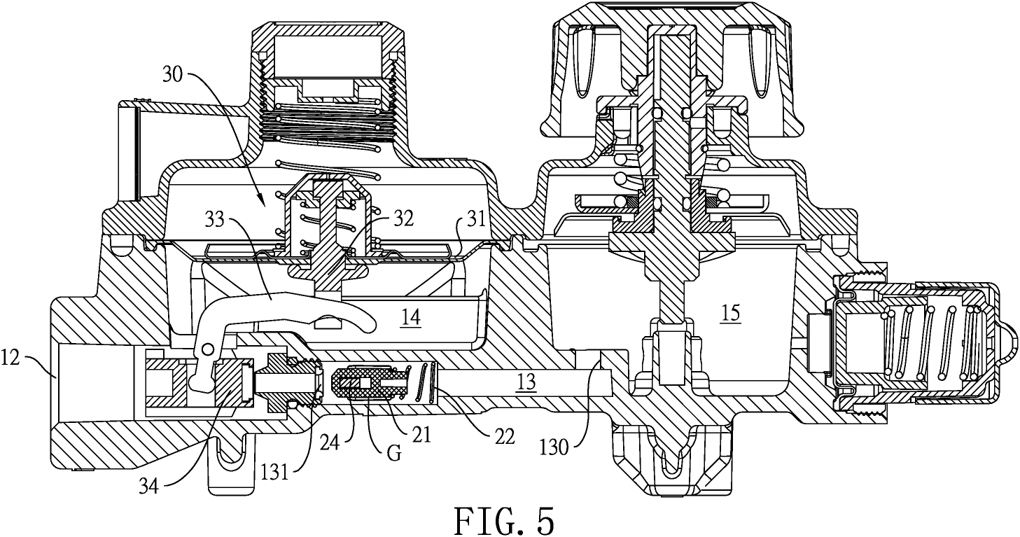

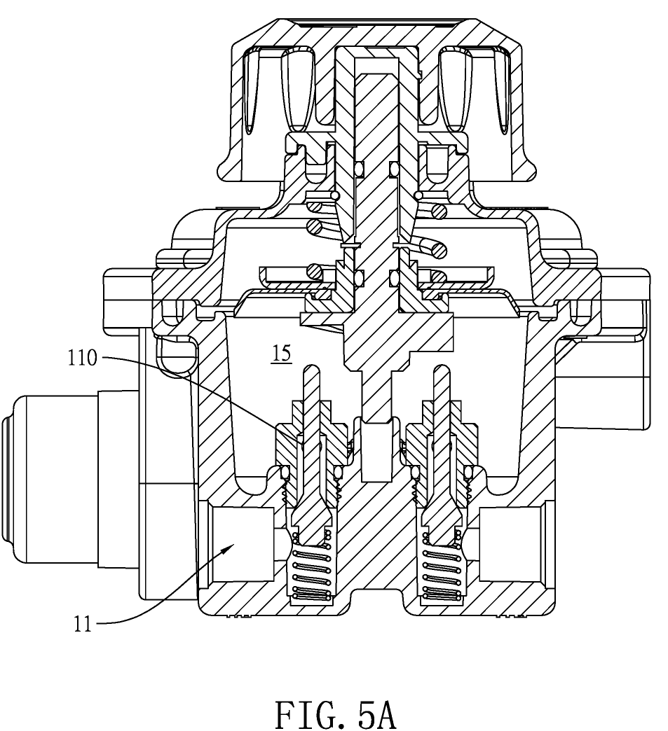

The base 10 has a gas inlet 11 and a gas outlet 12 and forms a transporting passage 13 and a first chamber 14 inside. The gas inlet 11 communicates with the first chamber 14 and the gas outlet 12 via the transporting passage 13. Gas is allowed to enter the base 10 via the gas inlet 11 and then flow to first chamber 14 and the gas outlet 12 through the transporting passage 13. Besides, in this embodiment, the base 10 forms a second chamber 15 inside. The gas inlet 11 communicates with the second chamber 15 and communicates with the transporting passage 13 via the second chamber 15. In other words, the gas inlet 11, the second chamber 15, the transporting passage 13, the first chamber 14 and the gas outlet 12 sequentially communicate with each other. The first chamber 14 communicates with an inner wall of a connecting passage between the transporting passage 13 and the gas outlet 12. With reference to FIGS. 5 and 5A, the gas inlet 11 communicates with the second chamber 15 via a communicating hole 110, and the second chamber 15 communicates with the transporting passage 13 via a communicating hole 130. In other words, in this embodiment, the base 10 is of the double-chamber type and is capable of adjusting a pressure of the gas through two chambers, but it is not limited thereto in other embodiments as the base 10 can also be implemented without the second chamber 15.

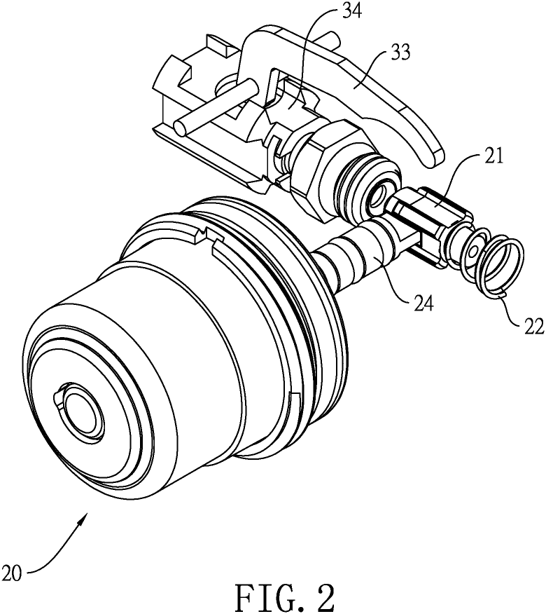

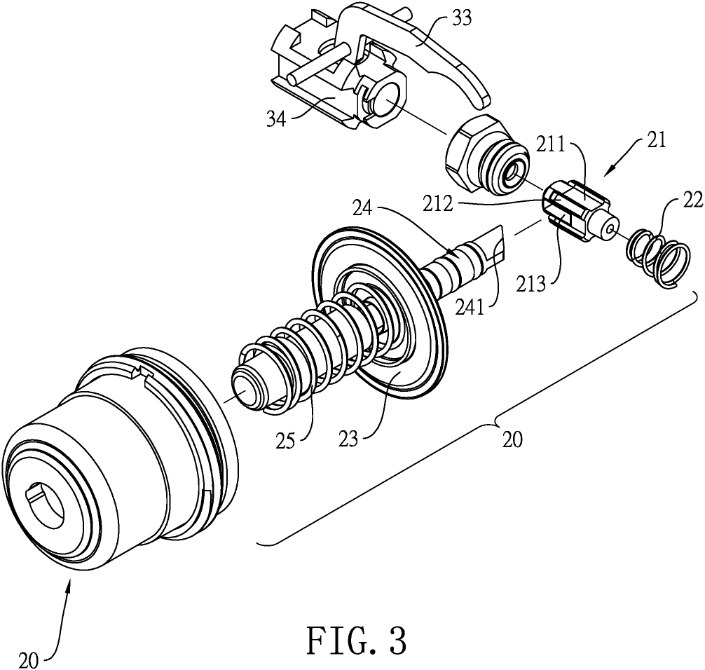

With reference to FIGS. 2 and 3, the blocking mechanism 20 has a plug 21, a first elastic unit 22, an elastic sealing sheet 23, a switching unit 24, and a second elastic unit 25.

The plug 21 is moveably mounted in the transporting passage 13 of the base 10. A gap G is formed between the plug 21 and an inner surface of the transporting passage 13. The gas is allowed to flow through the gap. Specifically, in this embodiment, the plug 21 has a rod body 211, multiple abutting segments 212, and an inserting hole 213. The gap G that allows the gas to pass through is formed between an outer annular surface of the rod body 211 and the inner surface of the transporting passage 13. The abutting segments 212 are mounted around the outer annular surface of the rod body 211, are spaced apart from each other, and abut the inner surface of the transporting passage 13. Thus, the abutting segments 212 support the rod body 211 and locate the rod body 211 in a center of the transporting passage 13, thereby forming the gap G. The inserting hole 213 is formed on the rod body 211.

The first elastic unit 22 is connected to the plug 21 and is configured to move the plug 21 to block an end opening 131 of the transporting passage 13 so that the gas inlet 11 and the gas outlet 12 are blocked. Specifically, in this embodiment, the first elastic unit 22 is a spring. An end of the spring abuts a stepped surface in the transporting passage 13 and the other end of the spring abuts an end of the plug 21. The spring pushes the plug 21 toward the end opening 131 of the transporting passage 13.

The elastic sealing sheet 23 is elastic and deformable. The elastic sealing sheet 23 can be a rubber membrane. A blocking chamber 231 is formed between the elastic sealing sheet 23 and the base 10 and communicates with the first chamber 14. The gas is allowed to push the elastic sealing sheet 23 to increase a volume of the blocking chamber 231. Specifically, since the blocking chamber 231 communicates with the first chamber 14, the pressure is the same in both the blocking chamber 231 and the first chamber 14. Therefore, if the pressure of the gas is larger than the elasticity of the elastic sealing sheet 23, the gas will push the elastic sealing sheet 23 from the blocking chamber 231 to deform the elastic sealing sheet 23 and to increase the volume of the blocking chamber 231.

The switching unit 24 is connected to the elastic sealing sheet 23 and moves along with the deformation of the elastic sealing sheet 23. The switching unit 24 is capable of abutting the plug 21 to make the plug 21 spaced apart from the end opening 131 of the transporting passage 13. When the gas pushes the elastic sealing sheet 23, the switching unit 24 is moved so that the plug 21 is allowed to be moved to block the end opening 131 of the transporting passage 13 by the first elastic unit 22. Specifically, in this embodiment, the switching unit 24 has an abutting inclined surface 241. The switching unit 24 abuts the plug 21 by the abutting inclined surface 241. When the gas pushes the elastic sealing sheet 23, the switching unit 24 moves relative to the plug 21, and the first elastic unit 22 makes the plug 21 slide relative to the abutting inclined surface 241 and moves the plug 21 toward the end opening 131 of the transporting passage 13. Besides, in this embodiment, the switching unit 24 is mounted in the inserting hole 213 of the plug 21 and abuts an inner surface of the inserting hole 213. But in other embodiments, the switching unit 24 can also abut an end of the plug 21 toward the end opening 131 of the transporting passage 13, and in that case the plug 21 can be implemented without the inserting hole 213. The switching unit 24 is capable of making the plug 21 spaced apart from the end opening 131 of the transporting passage 13 by more than 1 millimeter, and specifically, the switching unit 24 is capable of making the plug 21 spaced apart from the end opening 131 of the transporting passage 13 by 1.7 millimeters in this embodiment.

The second elastic unit 25 is connected to the elastic sealing sheet 23 and is configured to increase the volume of the blocking chamber 231. Specifically, in this embodiment, the second elastic unit 25 is a spring. The spring abuts a side surface of the blocking chamber 231 opposite to the blocking chamber 231 and pushes the elastic sealing sheet 23 toward the blocking chamber 231. In other words, the pressure of the gas must be larger than the elastic force of the second elastic unit 25 plus the elastic force of the elastic sealing sheet 23 to compress the second elastic unit 25 and deform the elastic sealing sheet 23.

The adjusting mechanism 30 is mounted in the first chamber 14 and is capable of adjusting the pressure of the gas in the first chamber 14. Specifically, in this embodiment, the adjusting mechanism 30 has an adjusting elastic sealing sheet 31, a moving unit 32, a lever 33, and an adjusting plug 34. The adjusting mechanism 30 works as the convectional gas regulator to adjust the pressure of the gas. But in other embodiments, the structure and the operation are not limited thereto, as the adjusting mechanism 30 can be implemented in any structure that adjusts the pressure of the gas.

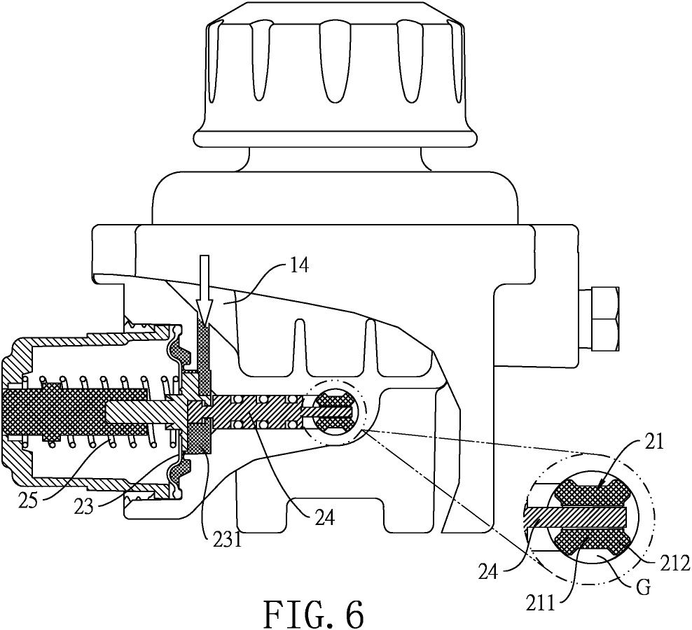

With reference to FIGS. 6, 7, 8, and 9, the operation of the blocking mechanism 20 is elaborated below.

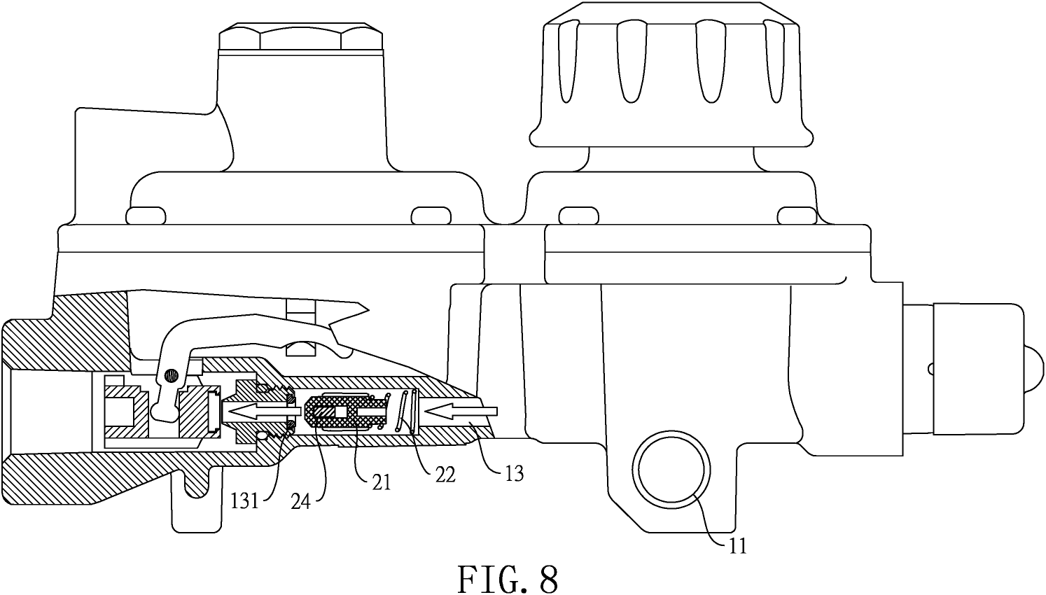

Under normal circumstances, with reference to FIGS. 6 and 8, when the pressure of the gas is within the set range, the switching unit 24 is pushed by the elastic forces of the second elastic unit 25 and the elastic sealing sheet 23 to abut the plug 21 and makes the plug 21 spaced apart from the end opening 131 of the transporting passage 13 via the abutting inclined surface 241. Therefore, the gas can enter through the gas inlet 11, passes through the gap G between the transporting passage 13 and the plug 21, and then flow to the gas outlet 12 and the first chamber 14 via the end opening 131. Since the first chamber 14 and the blocking chamber 231 communicate with each other, the pressure of the gas is the same in both the first chamber 14 and the blocking chamber 231.

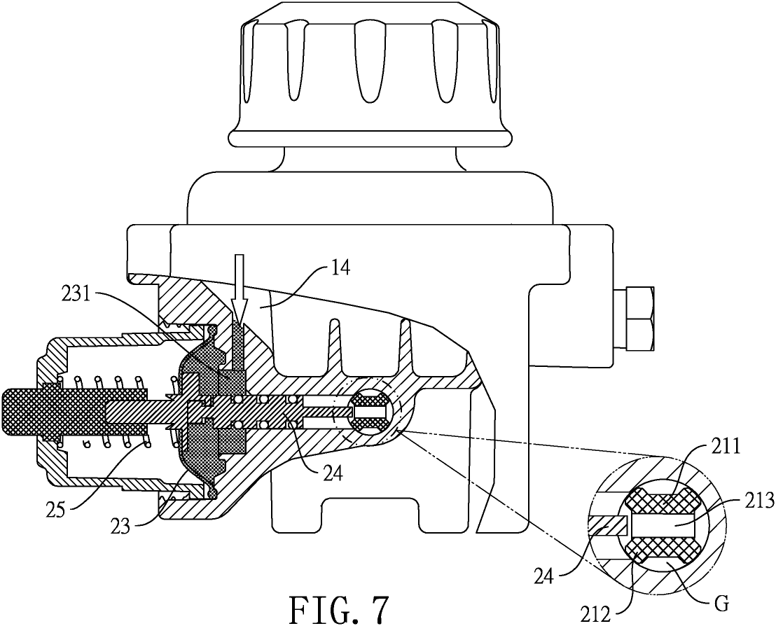

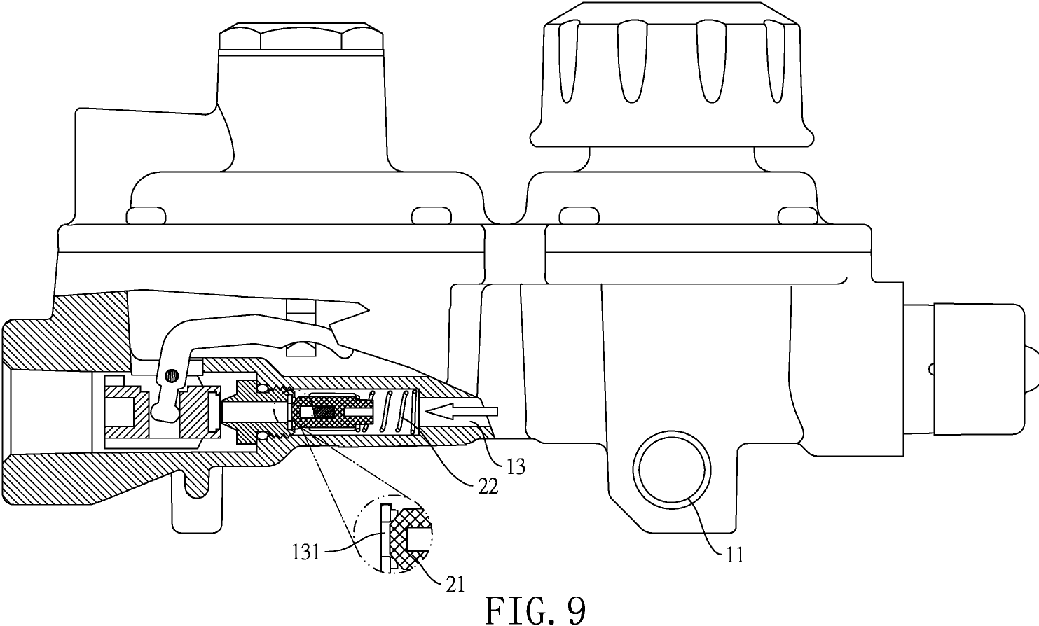

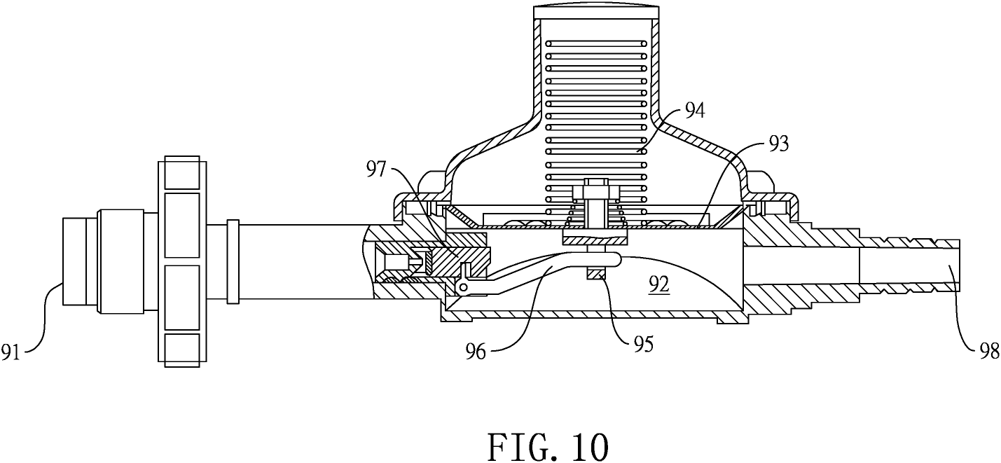

If the pressure of the gas is too high or the adjusting mechanism 30 fails, with reference to FIGS. 7 and 9, the gas pushes the elastic sealing sheet 23 from the blocking chamber 231 and the second elastic unit 25 to deform the elastic sealing sheet 23 and increase the volume of the blocking chamber 231. At the same time, the switching unit 24 is moved by the elastic sealing sheet 23 relative to the plug 21. On the other hand, the first elastic unit 22 keeps pushing the plug 21 and makes the plug 21 keep abutting the abutting inclined surface 241 of the switching unit 24, and then the plug 21 slides relative to the abutting inclined surface 241 and being moved toward the end opening 131 of the transporting passage 13. After the elastic sealing sheet 23 is deformed to a certain degree, which means the pressure of the gas is high enough, the switching unit 24 will be moved to a position that allows the plug 21 to be pushed against the end opening 131 by the first elastic unit 22, and therefore the end opening 131 is blocked and the gas is blocked as well.

But the structure and the operation of the blocking mechanism 20 are not limited to the abovementioned, as the switching unit 24 can also be implemented without the abutting inclined surface 241, and in such case, the switching unit 24 can be implemented as a latch to jam the plug 21.

When in use, under normal circumstances, the plug 21 is abutted by the switching unit 24 to be spaced apart from the end opening 131 of the transporting passage 13, and the gas can flow through the gap G between the plug 21 and the transporting passage 13 and then flow to the first chamber 14 and the gas outlet 12 via the end opening 131. If the gas pressure is too high or the adjusting mechanism 30 in the first chamber 14 fails, since the blocking chamber 231 communicates with the first chamber 14, the gas will push the elastic sealing sheet 23 from the blocking chamber 231 to deform the elastic sealing sheet 23. Then, the deformed elastic sealing sheet 23 moves the switching unit 24 relative to the plug 21, and allows the plug 21 to be moved by the first elastic unit 22 to block the end opening 131 of the transporting passage 13. As a result, the over-pressured gas can be blocked to avoid danger.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A gas regulator comprising:
a base having
a gas inlet;
a gas outlet;
a transporting passage formed inside the base; and
a first chamber formed inside the base; the gas inlet communicating with the first chamber and the gas outlet via the transporting passage; gas being capable of entering the base via the gas inlet;
a blocking mechanism having
a plug moveably mounted in the transporting passage of the base; a gap formed between the plug and an inner surface of the transporting passage; the gas allowed to flow through the gap;
a first elastic unit connected to the plug and configured to move the plug to block an end opening of the transporting passage so that the gas inlet and the gas outlet are blocked;
an elastic sealing sheet being elastic and deformable; a blocking chamber formed between the elastic sealing sheet and the base; the blocking chamber communicating with the first chamber; the gas allowed to push the elastic sealing sheet to increase a volume of the blocking chamber;
a second elastic unit connected to the elastic sealing sheet and configured to reduce the volume of the blocking chamber; and
a switching unit connected to the elastic sealing sheet and moving along with the deformation of the elastic sealing sheet relative to the plug; the switching unit being capable of abutting the plug to make the plug spaced apart from the end opening of the transporting passage; wherein when the gas pushes the elastic sealing sheet, the switching unit is moved so that the plug is allowed to be moved to block the end opening of the transporting passage by the first elastic unit; and
an adjusting mechanism mounted in the first chamber and being capable of adjusting a pressure of the gas in the first chamber.

2. The gas regulator as claimed in claim 1, wherein
the switching unit has
an abutting inclined surface; the switching unit abutting the plug by the abutting inclined surface; and
when the gas pushes the elastic sealing sheet, the switching unit moves relative to the plug, and the first elastic unit makes the plug slide relative to the abutting inclined surface and moves the plug toward the end opening of the transporting passage.

3. The gas regulator as claimed in claim 1, wherein
the plug has
an inserting hole; and
the switching unit is mounted in the inserting hole.

4. The gas regulator as claimed in claim 2, wherein
the plug has
an inserting hole; and
the switching unit is mounted in the inserting hole.

5. The gas regulator as claimed in claim 1, wherein
the plug has
a rod body; the gap formed between an outer annular surface of the rod body and the inner surface of the transporting passage; and
multiple abutting segments mounted around the outer annular surface of the rod body, spaced apart from each other, and abutting the inner surface of the transporting passage.

6. The gas regulator as claimed in claim 4, wherein
the plug has
a rod body; the gap formed between an outer annular surface of the rod body and the inner surface of the transporting passage; and
multiple abutting segments mounted around the outer annular surface of the rod body, spaced apart from each other, and abutting the inner surface of the transporting passage.

7. The gas regulator as claimed in claim 1, wherein the switching unit is capable of making the plug spaced apart from the end opening of the transporting passage by more than 1 millimeter.

8. The gas regulator as claimed in claim 6, wherein the switching unit is capable of making the plug spaced apart from the end opening of the transporting passage by more than 1 millimeter.

9. The gas regulator as claimed in claim 7, wherein the switching unit is capable of making the plug spaced apart from the end opening of the transporting passage by 1.7 millimeters.

10. The gas regulator as claimed in claim 8, wherein the switching unit is capable of making the plug spaced apart from the end opening of the transporting passage by 1.7 millimeters.

11. The gas regulator as claimed in claim 1, wherein
the base has
a second chamber formed inside the base; and
the gas inlet communicates with the second chamber and thus communicates with the transporting passage via the second chamber.

12. The gas regulator as claimed in claim 8, wherein
the base has
a second chamber formed inside the base; and
the gas inlet communicates with the second chamber and thus communicates with the transporting passage via the second chamber.
